(19) United States
(12) Patent Application Publication
(10) Pub. No.: US 2018/0119394 A1
(43) Pub. Date: May 3, 2018

(54) WATER PURIFIER WITH TWO CORES

(71) Applicant: Xiamen Runner Industrial Corporation, Xiamen (CN)

(72) Inventors: FENG-SHUN ZHAN, Xiamen (CN); BO-HUANG LIU, Xiamen (CN)

(21) Appl. No.: 15/655,891

(22) Filed: Jul. 21, 2017

(30) Foreign Application Priority Data
Oct. 27, 2016 (CN) 201621180609.2

(51) Int. Cl. E03C 1/02; F16K 11/074

(52) U.S. Cl. CPC E03C 1/02; F16K 11/0743

(57) ABSTRACT

A water purifier includes a body, a first core securely received in the body, a second core received in the body to be orthogonal to the first core, two primary inlets extending into the body and respectively independent to one another for connecting to two water sources of different qualities, a channel device securely received in the body having an inlet in communication with the inlet of the first core as well as one of the two primary inlets and an outlet in communication with the outlet of the first core as well as the inlet of the second core, a primary outlet in communication with the outlet of the outlet of the second core and an installation seat mounted on top of the channel device to connect the outlet of the channel device to the two inlets of the second core.

### CROSS REFERENCE

This application claims the priority of Chinese Application No. 201621180609.2, filed on Oct. 27, 2016 and the entirety thereof is herein incorporated with reference.

### TECHNICAL FIELD

The preferred embodiment of the present invention is related to a field of water purifier and, more particularly, to a water purifier with two cores to respectively communicate with two types of water sources of different water qualities.

### BACKGROUND OF THE INVENTION

Nowadays, a water purifier normally is equipped with a handle to control waterflow inside the water purifier. To those who frequently require two different types of water of different qualities, they often need to switch between a regular faucet for tap water and a water purifier for filtered water. That is, a family will have to install an additional faucet for the water purifier in addition to the regular faucet, which may occupy a portion of the already limited space and is costly.

### SUMMARY OF THE INVENTION

It is an objective of the preferred embodiment of the present invention to provide a handy water purifier having two cores installed therein.

In order to accomplish the abovementioned objective, the water purifier constructed in accordance with the preferred embodiment of the present invention includes a body a bottom end of which communicates with two inlets respectively in communication with two types of water sources of different water qualities and top end of which is connected to a primary outlet, a first core with two inlets and two outlets and a second core. The two inlets of the first core communicate with the two types of water sources of different water qualities and the two outlets of the first core communicate with two inlets of the second core whose outlet communicates with the primary outlet.

Another objective of the preferred embodiment of the present invention is that the body has an installation hole defined in a sidewall of the body to accommodate therein the first core and the second core is installed in a top portion inside the body with assistance of an installation seat to have a right angle relative to the first core. The installation seat has first waterways defined in a bottom portion thereof to connect the two inlets of the first core to the two types of water sources of different qualities and second waterways to connect the two outlets of the first core to two inlets of the second core.

Still another objective of the preferred embodiment of the present invention is that the primary outlet communicates with the outlets of the second core via the second waterways.

A further objective of the preferred embodiment of the present invention is that a first control device is installed on a side of the body to control rotation of a first shaft of the first core and a second control device is installed on top of the body to control rotation of a second shaft of the second core.

A further objective of the preferred embodiment of the present invention is to provide a water purifier comprising a body provided with a first installation hole defined in a side face thereof and a second installation hole; a first core securely received in the first installation hole and having two inlets and two outlets; a second core securely received in the second installation hole and having two inlets and an outlet; two primary inlets extending into the body and respectively independent to one another for connecting to two water sources of different qualities; a channel device securely received in the body having an inlet in communication with the inlet of the first core as well as one of the two primary inlets and an outlet in communication with the outlet of the first core as well as the inlet of the second core; a primary outlet in communication with the outlet of the outlet of the second core; and an installation seat mounted on top of the channel device to connect the outlet of the channel device to the two inlets of the second core.

Still another objective of the preferred embodiment of the present invention is that the first installation hole is orthogonal to the second installation hole.

Still another objective of the preferred embodiment of the present invention is that first core is orthogonal to the second core.

Still another objective of the preferred embodiment of the present invention is that a first knob is provided to the body to control rotation of the first core for controlling water flow.

Still another objective of the preferred embodiment of the present invention is that a second knob is provided to the body to control rotation of the second core for controlling water flow.

### BRIEF DESCRIPTION OF THE DRAWINGS

FIG. 1 is a schematic perspective view of the water purifier of the preferred embodiment of the present invention;

FIG. 2 is an exploded perspective view of the water purifier shown in FIG. 1 of the preferred embodiment of the present invention;

FIG. 3 is a perspective view of a channel device of the water purifier of the preferred embodiment of the present invention;

FIG. 4 is a perspective view of an installation seat of the preferred embodiment of the present invention;

FIG. 5 is a schematic cross-sectional view showing the internal structure of the water purifier of the preferred embodiment of the present invention; and

FIG. 6 is a cross sectional view according to line A-A of FIG. 5.

### DETAILED DESCRIPTION OF THE PREFERRED EMBODIMENT

Preferred embodiment(s) of the present invention in combination with the attached drawings shall be provided in detail in the following description. However, the given description is for example purpose only and should not be deemed as a limiting to the scope of the present invention in any way.

In order to make it easy to carry out the preferred embodiment of the present invention, a detailed description of the parts of the invention, supported with figures is provided here. As each part of the preferred embodiment of the present invention has many features, it is made easy to read, by referring to each feature with a number included in the parts description text. The number of the parts feature(s) is indicated here by starting it sequentially from the number 100, wherever a part feature appears in a text, an associated serial number is directly assigned.

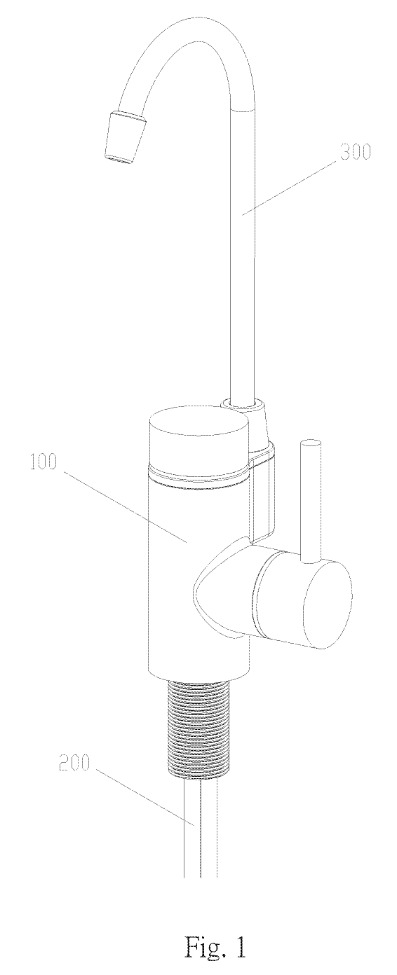

With reference to FIG. 1, the water purifier constructed in accordance with the preferred embodiment of the present invention includes a body 100, a first primary inlet pipe 200 and a second primary inlet pipe 201 respectively in communication with two types of water sources of different qualities and a primary outlet 300.

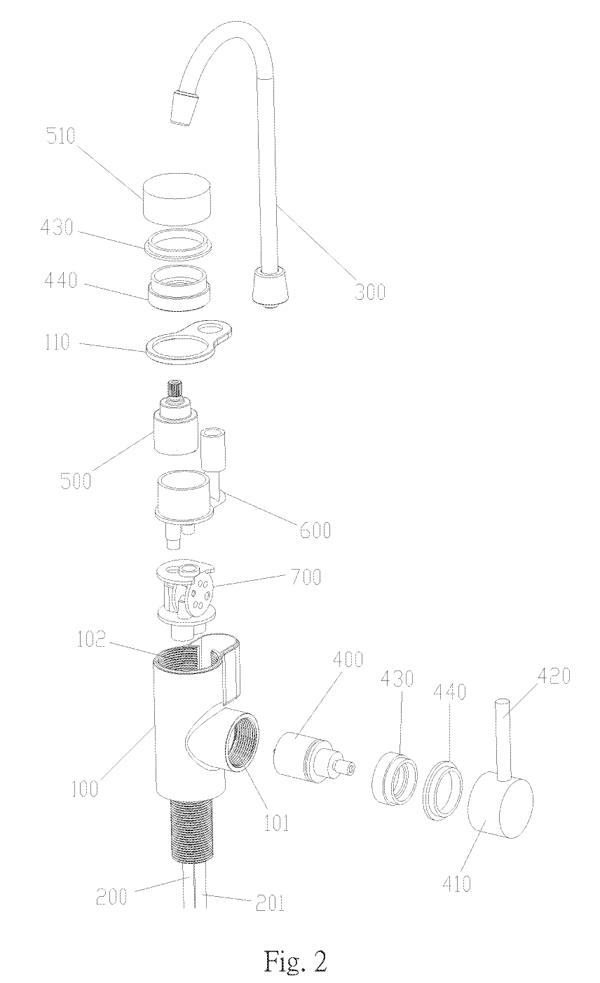

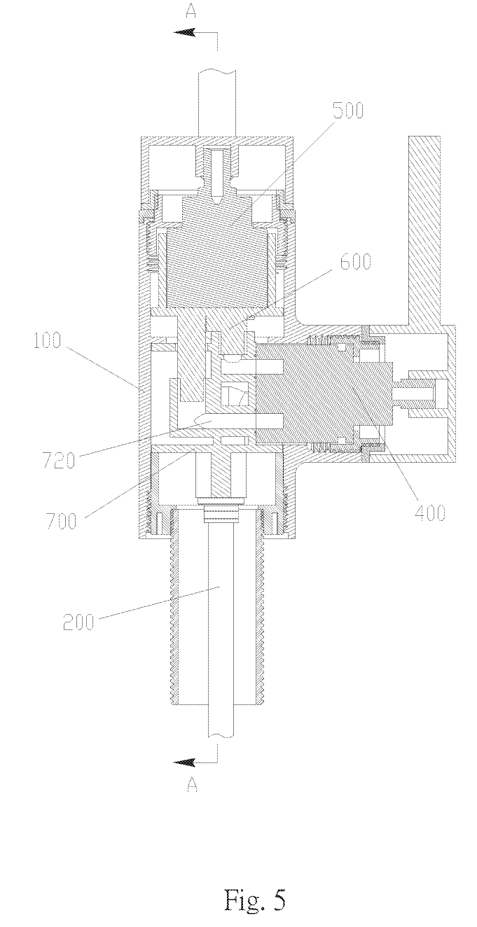

With reference to FIG. 2, it is to be noted that the body 100 is an annular hollow body with a first installation hole 101 defined in a sidewall of the body 100 and a second installation hole 102 vertically defined through the body 100 to communicate with the first installation hole 101. The first primary inlet pipe 200 and the second primary inlet pipe 201 are extended into the body 100 from a bottom face of the body 100. A first core 400 with two inlets and two outlets is installed inside the first installation hole 101. Inside the second installation hole 102, a channel device 700, an installation seat 600 and a second core 500 are installed. The first primary inlet pipe 200 and the second primary inlet pipe 201 respectively communicate with the two inlets of the first core 400 and two outlets of the first core 400 respectively communicate with two inlets of the second core 500. An outlet of the second core 500 communicates with an inlet of the primary outlet 300. After the first core 400 is inserted inside the first installation hole 101, a pressing ring 430 is extended into the first installation hole 101 to abut a peripheral face of the first core 400 so as to secure the position of the first core 400 inside the first installation hole 101. A first knob 410 with a handle 420 is rotatably mounted on the outside of the first installation hole 101 to control a shaft of the first core 400 so that the rotation of the first knob 410 controls the rotation of the shaft, which in turn, determines volume of waterflow through the first core 400. Thereafter a friction ring 430 is added between the first knob 410 and the pressing ring 430 to withstand wear from the rotation of the first knob 410 to the body 100, as shown in FIG. 5.

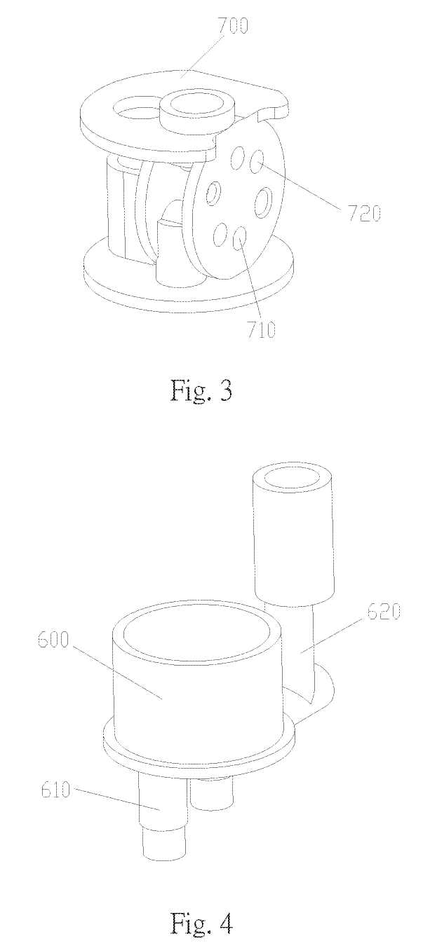

With reference to FIGS. 3, 4, 5 and 6, as previously described, the channel device 700 is received inside the second installation hole 102 and has an inlet 710 connecting the first primary inlet 200 and the second primary inlet 210 to the two inlets of the first core 400 and an outlet 720. The second core 500 is firmly received inside the installation seat 600 which has an inlet 610 and an outlet 620. The outlet 720 of the channel 700 communicates with the inlets of the second core 500 via the inlet 610 of the installation seat 600. The outlet 620 communicates with the outlet of the second core 500.

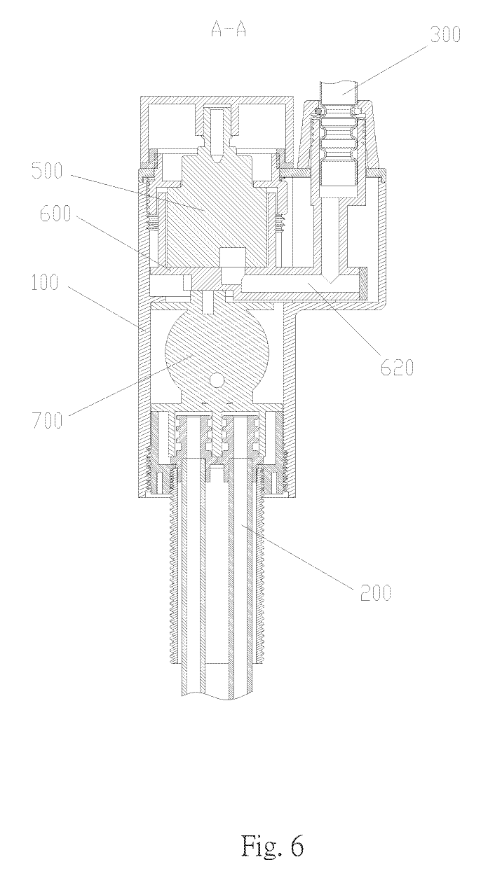

With reference to FIGS. 5 and 6, it is to be noted that after the water purifier of the preferred embodiment of the present invention is assembled, the first core 400 and the second core 500 are mutually orthogonal with respect to one another, which reduces the overall size of the conventional water purifier.

When the water purifier of the preferred embodiment of the present invention is in operation, the operator is able to rotate the first knob 410 with the assistance of the handle 420 to control water inflow from either the first primary inlet 200 or the second primary inlet 210 via the first core 400. Also, the operator is able to rotate the second knob 510 to control water inflow from either the second primary inlet 210 or the first primary inlet 200. Thereafter, after the primary outlet 300 is mounted on top of the second core 500 and communicates with the second core 500, water flow regulated by both the first core 400 and the second core 500 is able to flow out of the primary outlet 300.

After a detailed description of the preferred embodiment(s) has been provided, any skilled person in the art would easily understand the description so provided is for example purpose only. The scope for protection of the present invention is defined by the attached claims. Any skilled person in the art would easily amend, modify or alter the elements/devices of the present invention without departing from the principle essence and spirit of the present invention. However, the amendment, modification or alteration shall fall within the protection scope sought of the present invention.

What is claimed is:

1. A water purifier comprising:
a body provided with a first installation hole defined in a side face thereof and a second installation hole;
a first core securely received in the first installation hole and having two inlets and two outlets;
a second core securely received in the second installation hole and having two inlets and an outlet;
two primary inlets extending into the body and respectively independent to one another for connecting to two water sources of different qualities;
a channel device securely received in the body having an inlet in communication with the inlet of the first core as well as one of the two primary inlets and an outlet in communication with the outlet of the first core as well as the inlet of the second core;
a primary outlet in communication with the outlet of the outlet of the second core; and
an installation seat mounted on top of the channel device to connect the outlet of the channel device to the two inlets of the second core.

2. The water purifier as claimed in claim 1, wherein the first installation hole is orthogonal to the second installation hole.

3. The water purifier as claimed in claim 1, wherein the first core is orthogonal to the second core.

4. The water purifier as claimed in claim 1 further comprising a first knob to control rotation of the first core for controlling water flow.

5. The water purifier as claimed in claim 3 further comprising a first knob to control rotation of the first core for controlling water flow.

6. The water purifier as claimed in claim 1 further comprising a second knob to control rotation of the second core for controlling water flow.

7. The water purifier as claimed in claim 3 further comprising a second knob to control rotation of the second core for controlling water flow.

8. The water purifier as claimed in claim 5 further comprising a second knob to control rotation of the second core for controlling water flow.
